(19) United States
(12) Patent Application Publication
(10) Pub. No.: US 2016/0190539 A1
(43) Pub. Date: Jun. 30, 2016

(54) LITHIUM ION SECONDARY BATTERY

(71) Applicant: Automotive Energy Supply Corporation, Zama-shi (JP)

(72) Inventors: Shinichiro SAKAGUCHI, Zama-shi, Kanagawa (JP); Tsutomu OSHIMA, Zama-shi, Kanagawa (JP)

(73) Assignee: Automotive Energy Supply Corporation, Zama-shi (JP)

(21) Appl. No.: 14/972,448

(22) Filed: Dec. 17, 2015

(30) Foreign Application Priority Data
Dec. 26, 2014 (JP) 2014-266092

(51) Int. Cl. H01M 2/16; H01M 10/0525

(52) U.S. Cl. CPC H01M 2/1673; H01M 10/0525; H01M 2004/025

(57) ABSTRACT

A lithium ion secondary battery includes: a positive electrode mixture layer provided on a main plane of a positive electrode current collector; and an insulator covering a part of a surface of a gradually-decreasing portion included in the positive electrode mixture layer. A first region is smaller than a second region on a cross-section of the lithium ion secondary battery that is orthogonal to the main plane, the first region being defined by a perpendicular line to the main plane passing a contact point between the surface of the gradually-decreasing portion and an end of the insulator, the main plane, and the surface of the gradually-decreasing portion, and the second region being defined by an orthogonal line orthogonal to the perpendicular line and in contact with an upper surface of the positive electrode mixture layer on a plane including the cross-section, the perpendicular line, and the surface of the gradually-decreasing portion.

### CROSS-REFERENCE TO RELATED APPLICATION

This application claims priority from Japanese Patent Application No. 2014-266092 filed with the Japan Patent Office on Dec. 26, 2014, the entire content of which is hereby incorporated by reference.

### BACKGROUND

1. Technical Field

The present disclosure relates to a lithium ion secondary battery.

2. Related Art

To prevent the short-circuiting between a positive electrode and a negative electrode of a lithium ion secondary battery, a technique of providing a tape with an insulating property (hereinafter referred to as “insulating tape”) at a part of the positive electrode and/or the negative electrode has been known. For example, JP-A-2006-147392 discloses a lithium ion secondary battery configured such that an insulating tape covers a part of a main plane of a positive electrode current collector included in a positive electrode and a part of a surface of the portion of a positive electrode mixture layer applied on the positive electrode whose thickness decreases gradually toward the terminal of the application.

### SUMMARY

A lithium ion secondary battery according to an embodiment of this disclosure includes: a positive electrode mixture layer provided on a main plane of a positive electrode current collector and including a positive electrode active material intercalating or deintercalating lithium ions; a negative electrode mixture layer provided on a main plane of a negative electrode current collector and including a negative electrode active material intercalating or deintercalating lithium ions; an electrolyte layer provided between the positive electrode mixture layer and the negative electrode mixture layer; and an insulator covering a part of a surface of a gradually-decreasing portion included in the positive electrode mixture layer. The gradually-decreasing portion has thickness gradually decreasing toward a terminal of the positive electrode mixture layer; and a first region is smaller than a second region on a cross-section of the lithium ion secondary battery that is orthogonal to the main plane of the positive electrode current collector, the first region being defined by a perpendicular line to the main plane of the positive electrode current collector passing a contact point between the surface of the gradually-decreasing portion and an end of the insulator, the main plane of the positive electrode current collector, and the surface of the gradually-decreasing portion, and the second region being defined by an orthogonal line orthogonal to the perpendicular line and in contact with an upper surface of the positive electrode mixture layer on a plane including the cross-section, the perpendicular line, and the surface of the gradually-decreasing portion.

### BRIEF DESCRIPTION OF DRAWINGS

FIG. 1 is a perspective view schematically illustrating an example of a lithium ion secondary battery according to an embodiment;

FIG. 2 is a schematic sectional view taken along line I-I of the lithium ion secondary battery illustrated in FIG. 1;

FIG. 3 is a magnified view illustrating a portion surrounded by a line II in FIG. 2;

FIG. 4 is a magnified view of an end portion of a positive electrode active material layer according to a comparative example; and

FIG. 5 is a magnified view of the portion of FIG. 2 surrounded by the line II according to a modified example of the embodiment.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In the first charging of the lithium ion secondary battery with the configuration disclosed in JP-A-2006-147392, when lithium ions are deintercalated from the positive electrode mixture layer, lithium ions included in a region below the covered surface join lithium ions included in a region below the uncovered surface. The “covered surface” refers to a part of the surface of a later-described gradually-decreasing portion of the positive electrode mixture layer, the part being covered with the insulating tape. The “uncovered surface” refers to a part of the surface of the gradually-decreased portion, the part being not covered with the insulating tape. The “gradually-decreased portion” refers to a terminal portion of the positive electrode mixture layer whose thickness gradually decreases toward the terminal of the positive electrode mixture layer. For this reason, the flow of lithium ions concentrates in the region below the uncovered surface. As a result, not only the lithium ions included in the region below the uncovered surface but also the lithium ions included in the region below the covered surface are deintercalated from the uncovered surface.

In the conventional configuration as disclosed in JP-A-2006-147392, however, the negative electrode mixture layer opposite to the positive electrode mixture layer is not designed to enable the intercalation of all the lithium ions included in the region below the uncovered surface and the lithium ions included in the region below the covered surface. Therefore, in some cases, the lithium ions that are not intercalated into the negative electrode mixture layer are separated out on the surface of the negative electrode as metal lithium or a lithium compound (hereinafter the metal lithium and the lithium compound are also collectively referred to as “lithium compound”). The lithium compound separated out on the surface of the negative electrode may reduce the battery performance.

An object of the present disclosure is to solve the above problem, i.e., to prevent the degradation in battery performance of a lithium ion secondary battery due to the separation of the lithium compound.

A lithium ion secondary battery according to an embodiment of the present disclosure includes: a positive electrode mixture layer provided on a main plane of a positive electrode current collector and including a positive electrode active material intercalating or deintercalating lithium ions; a negative electrode mixture layer provided on a main plane of a negative electrode current collector and including a negative electrode active material intercalating or deintercalating lithium ions; an electrolyte layer provided between the positive electrode mixture layer and the negative electrode mixture layer; and an insulator covering a part of a surface of a gradually-decreasing portion included in the positive electrode mixture layer. The gradually-decreasing portion has thickness gradually decreasing toward a terminal of the positive electrode mixture layer; and a first region is smaller than a second region on a cross-section of the lithium ion secondary battery that is orthogonal to the main plane of the positive electrode current collector, the first region being defined by a perpendicular line to the main plane of the positive electrode current collector passing a contact point between the surface of the gradually-decreasing portion and an end of the insulator, the main plane of the positive electrode current collector, and the surface of the gradually-decreasing portion, and the second region being defined by an orthogonal line orthogonal to the perpendicular line and in contact with an upper surface of the positive electrode mixture layer on a plane including the cross-section, the perpendicular line, and the surface of the gradually-decreasing portion.

The surface of the gradually-decreasing portion of the positive electrode mixture layer in the lithium ion secondary battery may have a tangent line that is in contact with the surface at two or more contact points and have a depressed part between at least the two adjacent contact points on the tangent line. The end of the insulator may be positioned between any two adjacent contact points.

According to the embodiment of the present disclosure, the degradation in battery performance of the lithium ion secondary battery caused by the separation of the lithium compound can be prevented.

The lithium ion secondary battery according to the present disclosure will be described below in detail.

### (1) Lithium Ion Secondary Battery

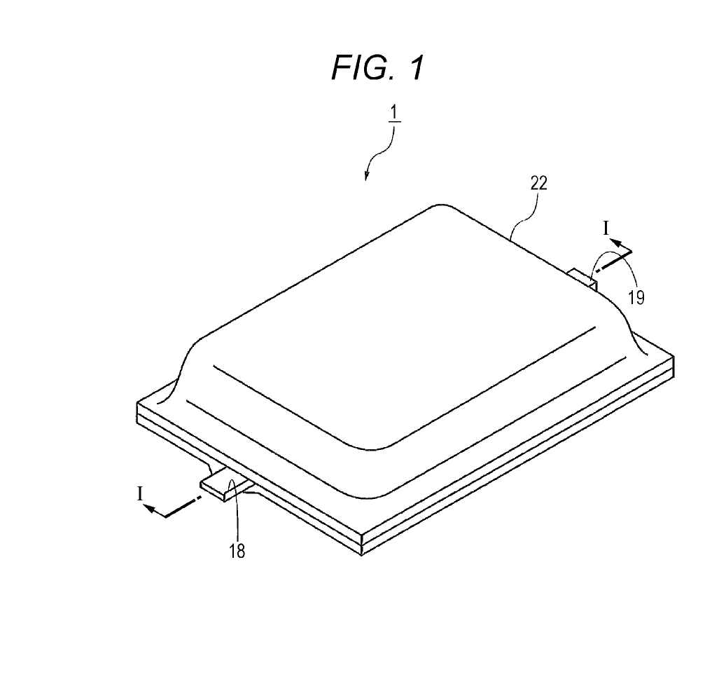

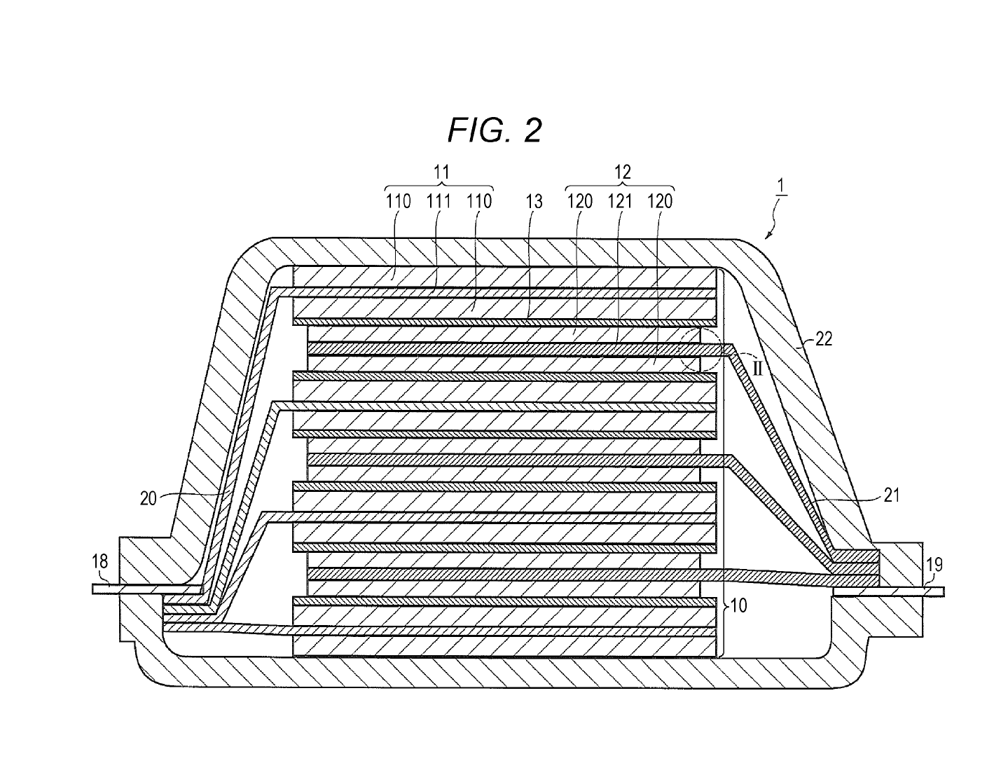

FIG. 1 is a perspective view schematically illustrating an example of a lithium ion secondary battery according to an embodiment of the present disclosure. FIG. 2 is a schematic sectional view taken along line I-I of the lithium ion secondary battery illustrated in FIG. 1. The lithium ion secondary battery of the present embodiment has a laminated film as an exterior material.

As illustrated in FIGS. 1 and 2, in the configuration of the lithium ion secondary battery 1 of the present embodiment, an approximately rectangular power generation element 10 in which the charging/discharging reaction is caused is sealed inside a laminated film 22 as an exterior material of the battery. Specifically, in the configuration of the lithium ion secondary battery, a composite laminated film including a polymer layer and a metal layer is used as the exterior material of the battery. Then, the entire exterior material around the power generation element 10 housed in the exterior material is bonded through heat-sealing, so that the power generation element 10 is sealed inside the exterior material.

The power generation element 10 is configured to have negative electrodes 11, electrolyte layers 13, and positive electrodes 12 that are stacked. The negative electrode 11 includes a negative electrode mixture layer 110 disposed on each main plane of a negative electrode current collector 111 (one surface of each of the negative electrode current collectors disposed on the bottom and top of the power generation element). The positive electrode 12 includes a positive electrode mixture layer 120 disposed on each main plane of a positive electrode current collector 121. Specifically, the negative electrode 11, the electrolyte layer 13, and the positive electrode 12 are stacked in this order so that one negative electrode mixture layer 110 is opposite to the positive electrode mixture layer 120 adjacent to the layer 110 with the electrolyte layer 13 interposed between the layer 110 and the layer 120.

Thus, the negative electrode 11, the electrolyte layer 13, and the positive electrode 12 that are adjacent to each other constitute one unit cell layer. The lithium ion secondary battery 1 of the present embodiment has the structure where a plurality of unit cell layers is stacked and is electrically connected in parallel to each other. The negative electrode is provided as the outermost layer of the power generation element 10 on both sides.

The negative electrode current collectors 111 and the positive electrode current collectors 121 are respectively provided with a negative electrode tab 18 and a positive electrode tab 19 that are electrically connected to the electrodes (negative electrode 11 and positive electrode 12). The negative electrode tab 18 and the positive electrode tab 19 are held by the ends of the laminated film 22 and led out of the laminated film 22. The negative electrode tab 18 and the positive electrode tab 19 may be respectively attached to the negative electrode current collector 111 and the positive electrode current collector 121 through a negative electrode terminal lead 20 and a positive electrode terminal lead 21 through ultrasonic welding or resistance welding, if necessary (FIG. 2 illustrates the embodiment of this case). The extended part of the negative electrode current collector 111 may be led out of the laminated film 22 and serve as the negative electrode tab 18. Similarly, the extended part of the positive electrode current collector 121 may be led out of the battery exterior material and serve as the positive electrode tab 19.

Components constituting the lithium ion secondary battery of the present embodiment will be briefly described below. These components are not limited to the components below only. The conventionally known components can be employed similarly.

### (1-1) Positive Electrode or Negative Electrode

### (1-1-1) Current Collector

The current collector is formed of a conductive material. The current collector provided with an active material layer disposed on each surface thereof forms the electrode of the battery.

The material of the current collector is not particularly limited, and may be metal, for example. Specific examples of the metal include aluminum, nickel, iron, stainless steel, titanium, and copper. Moreover, a clad material of nickel and aluminum, a clad material of copper and aluminum, or a plated material having a combination of these metals can be used. A metal foil with a surface covered with aluminum may be used. Above all, from the viewpoint of the electron conductivity and the battery operation potential, aluminum, stainless steel, and copper may be employed.

The size of the current collector is determined in accordance with the intended purpose of the battery. For example, the large-sized battery required to have high energy density employs the current collector with a large area. The thickness of the current collector is not particularly limited, and is usually 1 to 100 μm, for example.

### (1-1-2) Positive Electrode Mixture Layer

The positive electrode mixture layer includes the positive electrode active material. The positive electrode active material has a composition capable of intercalating ions in the discharging and deintercalating ions in the charging. An example of such a positive electrode active material is a lithium-transition metal composite oxide corresponding to a composite oxide of transition metal and lithium. Specific examples thereof include a Li—Co-based composite oxide such as LiCoO₂, a Li—Ni-based composite oxide such as LiNiO₂, a Li—Mn-based composite oxide with a spinel structure, such as LiMn₂O₄, a Li—Fe-based composite oxide such as LiFeO₂, and a composite oxide obtained by replacing a part of the transition metal of these composite oxides with another element. The lithium-transition metal composite oxide has excellent reactivity and cycle characteristics, and is inexpensive. Thus, the use of these materials for the electrode can produce the battery with the excellent output characteristic. Examples of the positive electrode active material include a phosphate compound and a sulfate compound including transition metal and lithium, such as LiFePO₄, a transition metal oxide and sulfide, such as V₂O₅, MnO₂, TiS₂, MoS₂, and MoO₃, and PbO₂, AgO, and NiOOH. Any of these positive electrode active materials may be used alone or in combination of two or more.

The average particle diameter of the positive electrode active material is not particularly limited, and may be set in the range of 1 to 100 μm, particularly 1 to 20 μm, from the viewpoint of the higher capacity, the reactivity, and the cycle durability of the positive electrode active material. When the average particle diameter is in such a range, the increase in internal resistance of the secondary battery in the charging and discharging under a high-output condition is suppressed. This enables the extraction of a sufficient amount of current. In the case where the positive electrode active material is in the form of the secondary particles, the average particle diameter of the primary particle included in the secondary particle is set in the range of 10 nm to 1 μm. In the present embodiment, however, the average particle diameter is not necessarily limited to the above range. It is needless to say that the positive electrode active material is not necessarily made into the secondary particles through the cohesion or bulking, depending on the fabrication method. The particle diameter of the positive electrode active material and the particle diameter of the primary particle may be the median size obtained by the laser diffraction method. The shape of the positive electrode active material depends on the kind of and the fabrication method for the positive electrode active material. For example, the shape may be a spherical shape (in the form of powder), a plate-like shape, a needle-like shape, a columnar shape, or a rectangular shape. The shape of the positive electrode active material, however, is not limited thereto. The positive electrode active material can have any other shape. The optimum shape for improving the battery characteristics including the charging/discharging characteristics can be selected as appropriate.

### (1-1-3) Negative Electrode Mixture Layer

The negative electrode mixture layer includes a negative electrode active material. The negative electrode active material has a composition capable of deintercalating ions in the discharging and intercalating ions in the charging. The negative electrode active material is not particularly limited, and may be any material that can intercalate and deintercalate lithium ions reversibly. Examples of the negative electrode active material include metals such as Si and Sn, metal oxides such as TiO, Ti₂O₃, TiO₂, SiO₂, SiO, and SnO₂, a composite oxide of lithium and a transition metal, such as Li_{4/3}Ti_{5/3}O₄ and Li₇MnN, Li—Pb-based alloy, Li—Al-based alloy, Li, and carbon materials such as natural graphite, synthetic graphite, carbon black, activated carbon, carbon fiber, coke, soft carbon, and hard carbon. Any of these negative electrode active materials may be used alone or used in combination of two or more.

The particle diameter and the shape of the negative electrode active material are not particularly limited, and the negative electrode active material can have any shape.

The active material layer may include another material if necessary, and may include, for example, a conductive auxiliary agent and a binder. If the active material layer includes an ion-conductive polymer, the active material layer may include a polymerization initiator for polymerizing the polymer.

The conductive auxiliary agent refers to an addition that is mixed for improving the conductivity of the active material layer. Examples of the conductive auxiliary agent include carbon powder of acetylene black, carbon black, Ketjen black, or graphite, various kinds of carbon fiber such as vapor grown carbon fiber (VGCF, registered trademark), and expanded graphite. The conductive auxiliary agent to be employed in this embodiment is not limited to those above.

Examples of the binder used in this embodiment include polyvinylidene fluoride (PVdF), polyimide, PTFE, SBR, and synthetic rubber binder. The binder to be employed in this embodiment is not limited to the above examples.

The mixing ratio of the components included in the active material layer is not particularly limited. The mixing ratio is adjusted on the basis of the public knowledge of the lithium ion secondary battery. The thickness of the active material layer is not particularly limited, and may be determined on the basis of the public knowledge of the lithium ion secondary battery. In an example, the thickness of the active material layer is set to, for example, 10 to 100 μm and particularly 20 to 50 μm. When the active material layer has a thickness of 10 μm or more, the battery can have sufficient capacity. On the other hand, when the active material layer has a thickness of 100 μm or less, it is possible to suppress the problem that the internal resistance is increased because the lithium ion is diffused less easily to the deep part of the electrode (to the current collector side).

### (1-1-4) Electrolyte Layer

The electrolyte layer according to this embodiment includes the liquid electrolyte or the polymer gel electrolyte held in the separator.

### (1-1-5) Separator

The separator has a function of holding the electrolyte in order to conduct lithium ions between the positive electrode and the negative electrode and a function of partitioning between the positive electrode and the negative electrode. The material of the separator used in this embodiment is not particularly limited, and may be any known material. Examples of the separator include a porous sheet separator formed of a polymer material that can absorb, hold, or carry an electrolyte (especially, electrolyte solution) and a nonwoven fabric separator. Further, the separator may be formed of cellulose or ceramic.

Examples of the polymer material used for the porous sheet separator include polyolefin such as polyethylene (PE) and polypropylene (PP), polyethylene terephthalate, and polyimide. Examples of the nonwoven fabric separator include cotton, rayon, acetate, nylon, polyester, polyolefin such as polypropylene or polyethylene, polyimide, and aramid resin.

A fabrication method for the separator is not particularly limited. The separator according to the present embodiment can be fabricated with reference to the known procedure. For example, a porous sheet separator formed of a polymer material can be provided with micropores by having the polymer material stretched uniaxially or biaxially.

### (1-1-6) Electrolyte

The liquid electrolyte includes a lithium salt as a supporting electrolyte dissolved in the solvent. Examples of the solvent include dimethyl carbonate (DMC), diethyl carbonate (DEC), dipropyl carbonate (DPC), ethylmethyl carbonate (EMC), methyl propionate (MP), methyl acetate (MA), methyl formate (MF), 4-methyldioxolane (4MeDOL), dioxolane (DOL), 2-methyltetrahydrofuran (2MeTHF), tetrahydrofuran (THF), dimethoxyethane (DME), ethylene carbonate (EC), propylene carbonate (PC), butylene carbonate (BC), and y-butyrolactone (GBL). Any of these solvents may be used alone or a mixture of two or more of these solvents.

The supporting electrolyte (lithium salt) is not particularly limited. For example, the supporting electrolyte may be a salt including an anion of an inorganic acid, such as LiPF₆, LiBF₄, LiClO₄, LiAsF₆, LiTaF₆, LiSbF₆, LiAlCl₄, Li₂B₁₀Cl₁₀, LiI, LiBr, LiCl, LiAlCl, LiHF₂, and LiSCN, and a salt including an anion of an organic acid, such as LiCF₃SO₃, Li(CF₃SO₂)₂N, LiBOB (lithium bis(oxalate) borate), and LiBETI (lithium bis(perfluoro ethyl sulfonyl imide), which is also expressed as Li(C₂F₅SO₂)₂N). Any of these electrolyte salts may be used alone or in combination of two or more of these electrolytes.

The polymer gel electrolyte is configured to include the above liquid electrolyte injected into a matrix polymer with lithium ion conductivity. Examples of the matrix polymer with the lithium ion conductivity include a polymer having polyethylene oxide in a main chain or a side chain (PEO), a polymer having polypropylene oxide in a main chain or a side chain (PPO), polyethylene glycol (PEG), polyacrylonitrile (PAN), polymethacrylate, polyvinylidene fluoride (PVdF), a copolymer of polyvinylidene fluoride and hexafluoropropylene (PVdF-HFP), poly(methylacrylate) (PMA), and poly(methylmethacrylate) (PMMA). A mixture, a modified body, a derivative, a random copolymer, an alternating copolymer, a graft copolymer, and a block copolymer of any of the above polymers can be used. In particular, PEO, PPO, a copolymer of PEO and PPO, PVdF, and PVdF-HFP can be used. Such matrix polymers allow the sufficient dissolving of the electrolyte salt such as a lithium salt. The matrix polymer can exhibit the excellent mechanical strength when having a cross-linked structure.

### (1-2) Tab

As illustrated in FIGS. 1 and 2, a tab (positive electrode tab and negative electrode tab) electrically connected to the current collector is led out of the laminated film serving as the exterior body for the purpose of extracting current to the outside of the lithium ion secondary battery according to this embodiment.

The material of the tab is not particularly limited and may be any known highly conductive material that has been conventionally used as a tab for a lithium ion secondary battery. Examples of the material for the tab include a metal material such as aluminum, copper, titanium, nickel, stainless steel (SUS), and alloy thereof. Because of having the small weight, the corrosion resistance, and the high conductivity, aluminum or copper, particularly aluminum is used. The positive electrode tab and the negative electrode tab may be formed of the same material or different materials.

### (1-3) Positive Electrode Terminal Lead and Negative Electrode Terminal Lead

As illustrated in FIGS. 1 and 2, the current collectors are electrically connected to the tabs through the negative electrode terminal lead 20 and the positive electrode terminal lead 21 of the lithium ion secondary battery 1. The lead may be formed by an extension part of the current collector that is not provided with the positive electrode mixture layer nor the negative electrode mixture layer.

The positive electrode terminal lead and the negative electrode terminal lead can be formed of the known material used for the lithium ion secondary battery.

### (1-4) Exterior Material

The laminated film 22 as illustrated in FIG. 1 may be used as the exterior material, into which the power generation element 10 may be packed. The laminated film may have, for example, a three-layer structure in which polypropylene, aluminum, and nylon are stacked in this order. Alternatively, a known metal can case may be used.

### (2) End Portion of Positive Electrode

Next, an end portion of the positive electrode in the sectional view of the lithium ion secondary battery according to this embodiment will be described below.

### (2-1) Shape of End Portion of Positive Electrode

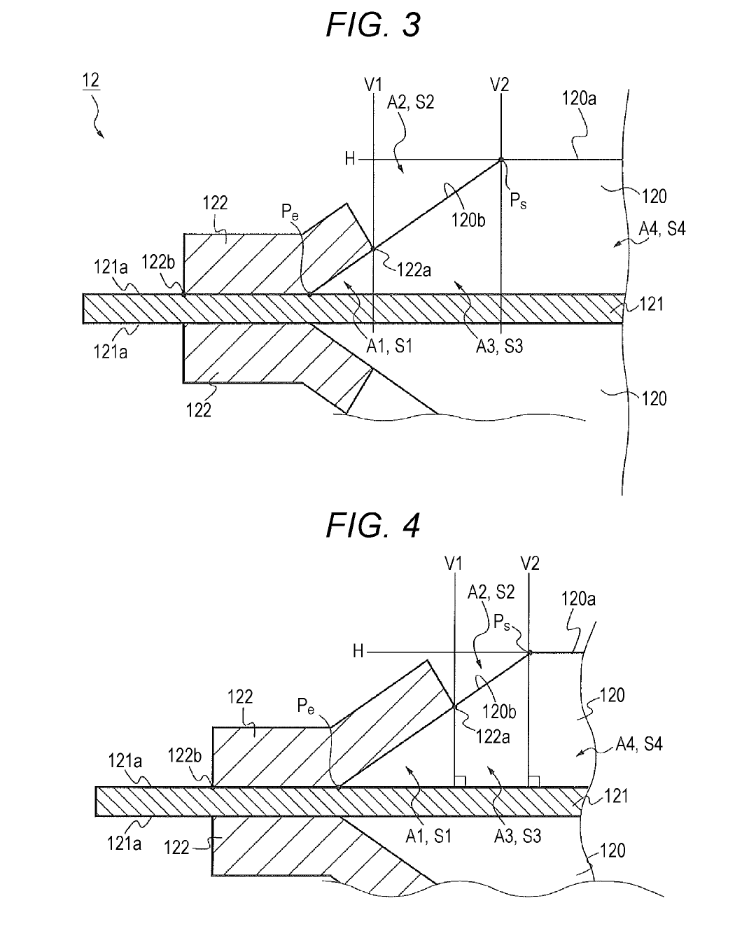

First, the shape of the end portion of the positive electrode in this embodiment will be described with reference to FIG. 3. FIG. 3 is a magnified view illustrating the portion surrounded by a line II in FIG. 2.

As illustrated in FIG. 3, at the end portion of the positive electrode 12 in this embodiment, the positive electrode mixture layer 120 formed on each main plane 121a of the positive electrode current collector 121 includes a portion (hereinafter referred to as “gradually-decreasing portion”) whose thickness gradually decreases from an upper surface 120a of the positive electrode mixture layer 120 toward the main plane 121a of the positive electrode current collector 121. The positive electrode mixture layer 120 is formed by applying a paste of a positive electrode mixture including the positive electrode active material onto the main plane 121a of the positive electrode current collector 121 with the use of a coater that discharges the paste. The sectional shape of the gradually-decreasing portion is controlled by opening and closing a valve that adjusts the amount of paste discharged from the nozzle of the coater (for example, adjusting the speed of closing the valve).

A point Ps, where the thickness of the positive electrode mixture layer 120 starts to decrease, is referred to as “gradual-decrease start point”. A surface 120b of the gradually-decreasing portion of the positive electrode mixture layer 120 is referred to as “gradually-decreasing surface”. An intersection Pe between the gradually-decreasing surface 120b and the main plane 121a of the positive electrode current collector 121 (i.e., the point where the thickness of the positive electrode mixture layer 120 is zero) is referred to as “gradual-decrease end point”.

A region ranging from a part of the main plane 121a of the positive electrode current collector 121, which is not provided with the positive electrode mixture layer 120, (i.e., the part opposite to the positive electrode mixture layer 120 relative to the gradual-decrease end point Pe) to a part of the gradually-decreasing surface 120b of the positive electrode mixture layer 120 is covered with an insulator 122.

In the ends 122a and 122b of the insulator 122 covering the above region, the end 122a on the gradually-decreasing surface 120b of the positive electrode mixture layer 120 is referred to as “a first end”, and the end 122b on the main plane 121a of the positive electrode current collector 121 is referred to as “a second end”.

A region of the gradually-decreasing surface 120b of the positive electrode mixture layer 120, which ranges from the first end 122a of the insulator 122 to the gradual-decrease end point Pe, corresponds to a surface covered with the insulator 122 (hereinafter referred to as “covered surface”). On the other hand, a region of the gradually-decreasing surface 120b of the positive electrode mixture layer 120, which ranges from the gradual-decrease start point Ps to the first end 122a of the insulator 122, corresponds to a surface uncovered with the insulator 122 (hereinafter referred to as “uncovered surface”).

### (2-2) Movement of Lithium Ions in End Portion of Positive Electrode

Next, the movement of lithium ions in the end portion of the positive electrode in this embodiment will be described below with reference to FIG. 3.

A region A1 of the positive electrode mixture layer 120, which is surrounded by a perpendicular line V1 from the contact point between the first end 122a and the gradually-decreasing surface 120b to the main plane 121a of the positive electrode current collector 121, the main plane 121a of the positive electrode current collector 121, and the gradually-decreasing surface 120b of the positive electrode mixture layer 120, is hereinafter referred to as “a first region”. The first region A1 of the positive electrode mixture layer 120 corresponds to the covered surface. In other words, a part of the gradually-decreasing surface 120b of the positive electrode mixture layer 120, which corresponds to the first region A1, is covered with the insulator 122. A region A2, which is surrounded by a line H which is in contact with the upper surface 120a of the positive electrode mixture layer 120 and is orthogonal to the perpendicular line V1 (hereinafter the line H is referred to as “orthogonal line”), the perpendicular line V1, and the gradually-decreasing surface 120b, is hereinafter referred to as “a second region”. A region A3 of the positive electrode mixture layer 120, which is surrounded by the perpendicular line V1, a perpendicular line V2 from the gradual-decrease start point Ps to the main plane 121a of the positive electrode current collector 121, the main plane 121a of the positive electrode current collector 121, and the gradually-decreasing surface 120b of the positive electrode mixture layer 120, is hereinafter referred to as “a third region.” The third region A3 of the positive electrode mixture layer 120 corresponds to the uncovered surface. In other words, the part of the gradually-decreasing surface 120b of the positive electrode mixture layer 120, which corresponds to the third region A3, is not covered with the insulator 122. Moreover, a region A4 of the positive electrode mixture layer 120 between the upper surface 120a and the main plane 121a of the positive electrode mixture layer 120 is referred to as “a fourth region.” The surface of the fourth region A4 of the positive electrode mixture layer 120, i.e., the upper surface 120a of the positive electrode mixture layer 120 is not covered with the insulator 122.

In the following description, the areas of the first region A1 to the fourth region A4 are denoted by S1 to S4, respectively. The area S1 of the first region A1 and the area S2 of the second region A2 are determined by the position of the perpendicular line V1. The position of the perpendicular line V1 is determined by the position of the first end 122a of the insulator 122. In other words, the area S1 of the first region A1 and the area S2 of the second region A2 are determined by the position of the first end 122a of the insulator 122. In this embodiment, the first end 122a of the insulator 122 is disposed at such a position that the area S1 of the first region A1 becomes smaller than the area S2 of the second region A2.

Each of the first region A1, the third region A3, and the fourth region A4 of the positive electrode mixture layer 120 includes the positive electrode active material whose amount is determined in accordance with the thickness of the positive electrode mixture layer 120. That is to say, the first region A1, the third region A3, and the fourth region A4 include the positive electrode active material whose amount corresponds to the area S1, the area S3, and the area S4, respectively.

On the surface of the first region A1 in the positive electrode mixture layer 120 is provided the insulator 122. Therefore, the lithium ions to be deintercalated from the positive electrode active material included in the first region do not come from the part, corresponding to the first region A1, of the gradually-decreasing surface 120b of the positive electrode mixture layer 120 (i.e., the covered surface). As a result, lithium ions move to the third region A3. On the other hand, the lithium ions to be deintercalated from the positive electrode active material included in the third region A3 in the positive electrode mixture layer 120 come from the part, corresponding to the third region A3, of the gradually-decreasing surface 120b of the positive electrode mixture layer 120 (i.e., the uncovered surface). Further, the lithium ions having moved from the first region A1 to the third region A3 are deintercalated from the part of the uncovered surface corresponding to the third region A3 in the gradually-decreasing surface 120b of the positive electrode mixture layer 120. That is to say, the part of the gradually-decreasing surface 120b of the positive electrode mixture layer 120, which corresponds to the third region A3 (i.e., the uncovered surface), not just releases the lithium ions from the positive electrode active material included in the third region A3 but also releases the lithium ions having moved from the positive electrode active material included in the first region A1.

### (3) Comparative Example and Advantageous Effect of the Embodiment

Next, a comparative example and the advantageous effects of the present embodiment will be described with reference to FIG. 4. FIG. 4 is a magnified view of an end portion of the positive electrode active material layer in the comparative example.

As illustrated in FIG. 4, the end portion of the positive electrode 12 in the comparative example is different from the end portion of the positive electrode 12 in this embodiment illustrated in FIG. 3 in that the first end 122a of the insulator 122 is disposed at such a position that the area S1 of the first region A1 becomes larger than the area S2 of the second region A2.

In general, the lithium ions deintercalated from the positive electrode mixture layer 120 are intercalated with the negative electrode active material included in the negative electrode mixture layer 110 opposite to the positive electrode mixture layer 120. Therefore, the upper limit of the amount of lithium ions that can be intercalated with the negative electrode active material (hereinafter referred to as “upper-limit intercalation amount”) is determined based on the amount of lithium ions deintercalated from the thickest part (i.e., the upper surface 120a) of the positive electrode mixture layer 120. In other words, the upper-limit intercalation amount of the negative electrode active material is determined as the maximum amount of lithium ions deintercalated from the positive electrode active material per unit area of the region, which is obtained based on the region with the thickness of the fourth region A4 (this amount is hereinafter also referred to as “amount of deintercalated lithium ions based on the region”). In this embodiment (FIG. 3) and the comparative example (FIG. 4), the thickness of the fourth region A4 is the same as the thickness of the total region including the second region A2 and the third region A3. Therefore, in this embodiment, the first end 122a of the insulator 122 is disposed so that the amount of deintercalated lithium ions based on this total region is not more than the upper-limit intercalation amount of negative electrode active material. As illustrated in FIG. 4, however, the first area S1 of the first region A1 is larger than the second area S2 of the second region A2 in the comparative example. Accordingly, the amount of deintercalated lithium ions based on the total region that are deintercalated from the portion corresponding to the third region A3 in the gradually-decreasing surface 120b of the positive electrode mixture layer 120 (i.e., lithium ions deintercalated from the positive electrode active material whose amount corresponds to the total of the first area S1 and the third area S3) may be more than the upper-limit intercalation amount of the negative electrode active material. If the amount of lithium ions deintercalated from the positive electrode mixture layer 120 is more than the upper-limit intercalation amount of the negative electrode active material, the lithium ions that are not intercalated by the negative electrode active material may turn into a metal lithium or lithium compound and separate out on the surface of the negative electrode. The metal lithium or lithium compound separated out on the surface of the negative electrode deteriorates the battery performance. In other words, in the comparative example, the performance of the lithium ion secondary battery possibly deteriorates depending on the position of the first end 122a of the insulator 122.

As illustrated in FIG. 3, the first area S1 is smaller than the second area S2 in this embodiment, which is different from the comparative example. The amount of deintercalated lithium ions based on the total region that are deintercalated from the portion corresponding to the third region A3 in the gradually-decreasing surface 120b of the positive electrode mixture layer 120 is less than the upper-limit intercalation amount of the negative electrode active material. This can suppress the phenomenon that the amount of lithium ions deintercalated from the positive electrode mixture layer 120 exceeds the upper-limit intercalation amount of negative electrode active material included in the negative electrode mixture layer 110. Therefore, it is possible to suppress the phenomenon that the lithium ions that are not intercalated with the negative electrode mixture layer 110 separate out on the surface of the negative electrode 11 as the metal lithium or the lithium compound. As a result, the degradation in battery performance caused by the lithium compound separated on the surface of the negative electrode 11 can be avoided.

### (4) Modified Example of the Embodiment

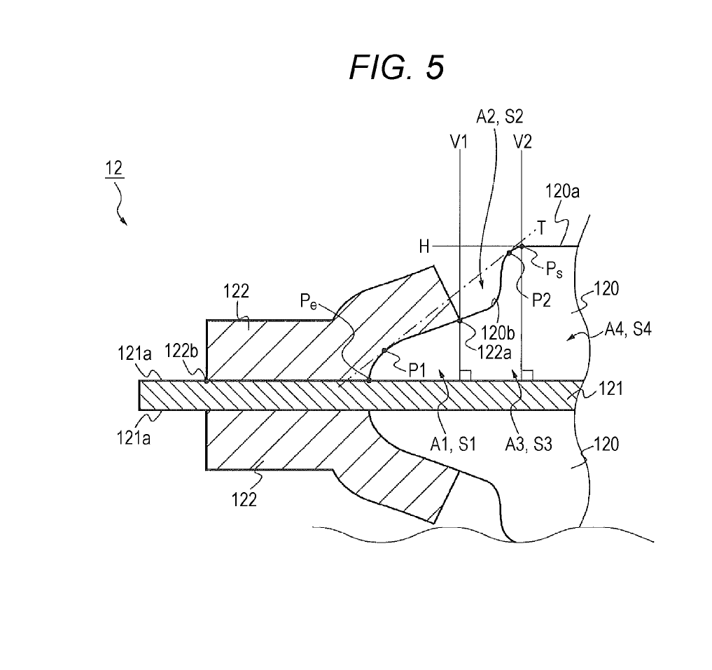

The shape of the end portion of the positive electrode according to a modified example of the embodiment will be described below with reference to FIG. 5. The behavior of lithium ions in the end portion of the positive electrode according to the modified example of the embodiment is similar to that of the embodiment. Thus, the description on the behavior of lithium ions will be omitted. FIG. 5 is a magnified view of the portion of FIG. 2 surrounded by the line II in the modified example of this embodiment.

As illustrated in FIG. 5, the end portion of the positive electrode 12 according to the modified example of the embodiment is different from that of the embodiment (FIG. 3) in the following points:

the gradual-decrease surface 120b of the positive electrode mixture layer 120 is formed to have the tangent line T in contact with the surface 120b at the first contact point P1 and the second contact point P2;

the gradual-decrease surface 120b of the positive electrode mixture layer 120 has the depressed part between the first contact point P1 and the second contact point P2; and

the first end 122a of the insulator 122 is positioned between the first contact point P1 and the second contact point P2.

In the modified example of the embodiment, the first area S1 and the third area S3 are smaller than the first area S1 and the third area S3 in the embodiment (FIG. 3), respectively. Therefore, the amount of lithium ions deintercalated from the portion corresponding to the third region A3 in the gradually-decreasing surface 120b of the positive electrode mixture layer 120 is smaller than that of the embodiment. Thus, it is possible to avoid the degradation in battery performance caused by the lithium compound separated out on the surface of the negative electrode 11, as compared to the embodiment. As described in this modified example, regardless of the state of the gradually-decreasing surface 120b of the positive electrode mixture layer 120, the effect of suppressing the separation of the lithium compound on the surface of the negative electrode 11 can be obtained as long as the area S1 of the first region A1 is smaller than the area S2 of the second region A2. The number of contact points between the tangent line T and the gradually-decreasing surface 120b may be three or more. In this case, the gradually-decreasing surface 120b has the depressed part between at least the two adjacent contact points on the tangent line T. The first end 122a is positioned between any two contact points with the depressed part interposed therebetween.

### (5) Summary of the Embodiment

The summary of this embodiment will be described below. The lithium ion secondary battery according to this embodiment includes the positive electrode mixture layer 120, the negative electrode mixture layer 110, the electrolyte layer 13, and the insulator 122. The positive electrode mixture layer 120 is provided on the main plane 121a of the positive electrode current collector 121, and includes the positive electrode active material intercalating or deintercalating lithium ions. The negative electrode mixture layer 110 is provided on the main plane of the negative electrode current collector 111, and includes the negative electrode active material intercalating or deintercalating lithium ions. The electrolyte layer 13 is provided between the positive electrode mixture layer 120 and the negative electrode mixture layer 110. The insulator 122 covers the region ranging from the part of the main plane 121a of the positive electrode current collector 121 that is not provided with the positive electrode mixture layer 120 to the part of the surface of the gradually-decreasing portion included in the positive electrode mixture layer 120 and having the decreasing thickness. Here, the first region A1 in the section of the lithium ion secondary battery orthogonal to the main plane 121a of the positive electrode current collector 121 is defined by the perpendicular line V1 of the main plane 121a of the positive electrode current collector 121 passing the contact point between the surface 120b of the gradually-decreasing portion and the end 122a of the insulator 122, the main plane 121a of the positive electrode current collector 121, and the surface 120b of the gradually-decreasing portion. Further, the second region A2 on the plane including the aforementioned section is defined by the orthogonal line H that is in contact with the upper surface 120a of the positive electrode mixture layer 120 and orthogonal to the perpendicular line V1, the perpendicular line V1, and the surface 120b of the gradually-decreasing portion. In this embodiment, the area S1 of the first region is smaller than the area S2 of the second region A2.

According to this embodiment, the degradation in battery performance of the lithium ion secondary battery caused by the separation of the lithium compound can be prevented.

Preferably, the surface 120b of the gradually-decreasing portion of the positive electrode mixture layer 120 may have the depressed shape between at least the two adjacent first contact point P1 and second contact point P2 on the tangent line T, and the end of the insulator may be positioned between the first contact point P1 and the second contact point P2.

In the lithium ion secondary battery with the above structure, the degradation in battery performance caused by the separation of the lithium compound on the surface of the negative electrode 11 can be reliably prevented. In particular, regardless of the state of the gradually-decreasing surface 120b of the positive electrode mixture layer 120, the effect of suppressing the separation of the lithium compound on the surface of the negative electrode 11 can be obtained as long as the area S1 of the first region A1 is smaller than the area S2 of the second region A2.

The embodiment of the present disclosure has been described above. However, the above embodiment merely describes an example of the embodiment according to the present disclosure. The gist of the embodiment is not to limit the disclosed technical range to the lithium ion secondary battery with the specific structure described in the above embodiment. For example, the present disclosure can be applied to a bipolar battery in which the current collectors each having the positive electrode active material layer formed on one surface and the negative electrode active material layer formed on the other surface that are alternately stacked with the electrolyte layer interposed therebetween.

The lithium ion secondary battery according to the embodiment of the present disclosure may be any of the following first and second lithium ion secondary batteries.

The first lithium ion secondary battery includes: a positive electrode mixture layer provided on a main plane of a positive electrode current collector and including a positive electrode active material intercalating or deintercalating lithium ions; a negative electrode mixture layer provided on a main plane of a negative electrode current collector and including a negative electrode active material intercalating or deintercalating lithium ions; an electrolyte layer provided between the positive electrode mixture layer and the negative electrode mixture layer; and an insulator covering a region ranging to a part of a surface of a gradually-decreasing portion of the positive electrode mixture layer having thickness gradually decreasing, wherein a first region is smaller than a second region in a section obtained by cutting the lithium ion secondary battery with a plane orthogonal to the main plane of the positive electrode current collector, the first region being defined by a perpendicular line being orthogonal to the main plane of the positive electrode current collector and passing a contact point between the surface of the gradually-decreasing portion of the positive electrode mixture layer and an end of the insulator, the main plane of the positive electrode current collector, and the surface of the gradually-decreasing portion, and the second region being defined by an orthogonal line being orthogonal to the perpendicular line and passing an upper surface of the positive electrode mixture layer, the perpendicular line, and the surface of the gradually-decreasing portion.

The second lithium ion secondary battery is the first lithium ion secondary battery, wherein the surface of the gradually-decreasing portion of the positive electrode mixture layer has a depressed shape between at least two contact points at which the surface is in contact with a tangent line, and the end of the insulator is positioned between the two contact points.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A lithium ion secondary battery comprising:
a positive electrode mixture layer provided on a main plane of a positive electrode current collector and including a positive electrode active material intercalating or deintercalating lithium ions;
a negative electrode mixture layer provided on a main plane of a negative electrode current collector and including a negative electrode active material intercalating or deintercalating lithium ions;
an electrolyte layer provided between the positive electrode mixture layer and the negative electrode mixture layer; and
an insulator covering a part of a surface of a gradually-decreasing portion included in the positive electrode mixture layer, wherein the gradually-decreasing portion has thickness gradually decreasing toward a terminal of the positive electrode mixture layer, and
a first region is smaller than a second region on a cross-section of the lithium ion secondary battery that is orthogonal to the main plane of the positive electrode current collector, the first region being defined by a perpendicular line to the main plane of the positive electrode current collector passing a contact point between the surface of the gradually-decreasing portion and an end of the insulator, the main plane of the positive electrode current collector, and the surface of the gradually-decreasing portion, and the second region being defined by an orthogonal line orthogonal to the perpendicular line and in contact with an upper surface of the positive electrode mixture layer on a plane including the cross-section, the perpendicular line, and the surface of the gradually-decreasing portion.

2. The lithium ion secondary battery according to claim 1, wherein
the surface of the gradually-decreasing portion of the positive electrode mixture layer has a tangent line that is in contact with the surface at two or more contact points, and has a depressed part between at least the two adjacent contact points on the tangent line, and
the end of the insulator is positioned between any two adjacent contact points.
